(19) United States
(12) Patent Application Publication
(10) Pub. No.: US 2011/0025794 A1
(43) Pub. Date: Feb. 3, 2011

(54) Inkjet head and inkjet head assembly

(75) Inventors: Yoon Sok Park, Suwon (KR); Jae Woo Joung, Suwon (KR); Jae Chan Park, Suwon (KR); Ju Hwan Yang, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,418

(22) Filed: Dec. 18, 2009

(30) Foreign Application Priority Data
Jul. 29, 2009 (KR) 10-2009-0069370

(51) Int. Cl. B41J 2/17

(52) U.S. Cl. 347/94

(57) ABSTRACT

There is provided an inkjet head including an inkjet head plate slantedly coupled to a cartridge supplying ink; a nozzle ejecting ink moving through a path formed inside the inkjet head plate, and formed at a flattened edge of the inkjet head plate contacting a printing medium; and an actuator provided on a surface of the inkjet head plate opposite to that coupled to the cartridge and controlling the ejection of the ink.

### CROSS-REFERENCE TO RELATED APPLICATIONS

This application claims the priority of Korean Patent Application No. 10-2009-0069370 filed on Jul. 29, 2009, in the Korean Intellectual Property Office, the disclosure of which is incorporated herein by reference.

### BACKGROUND OF THE INVENTION

1. Field of the Invention

The present invention relates to an inkjet head and an inkjet head assembly, and more particularly, to an inkjet head and an inkjet head assembly using a cartridge, coupled to the inkjet head at the outside of the inkjet head, as a substitute for a reservoir formed inside the inkjet head and containing ink, without forming the reservoir inside the inkjet head.

2. Description of the Related Art

In general, an inkjet head is a structure allowing for the ejection of ink droplets through a small nozzle by converting electrical signals into physical impulses. Particularly, an inkjet head assembly includes an inkjet head having a nozzle plate and a cartridge supplying ink to the inkjet head.

Recently, a piezoelectric inkjet head has been used in an industrial inkjet printer. For example, it is used to directly form a circuit pattern by applying ink made of melted metal such as gold or silver onto a printed circuit board (PCB), for creating industrial graphics or for the manufacturing of a liquid crystal display (LCD), an organic light emitting diode (OLED), a solar cell, and the like.

Inside an inkjet head of an industrial inkjet printer, there are provided an inlet and an outlet for the inflow and outflow of ink from a cartridge, a reservoir containing inflow ink, and a chamber transferring the driving power of an actuator so as to move ink inside the reservoir to a nozzle.

In this manner, a plurality of components are formed inside the inkjet head, and accordingly, the overall thickness of an inkjet head plate, stacked as a plurality of substrates, is increased.

Also, since the plurality of components need to be formed inside the inkjet head plate, there may be problems caused due to the complexity of manufacturing process, as well as an increase in the number of substrates required.

### SUMMARY OF THE INVENTION

An aspect of the present invention provides an inkjet head and an inkjet head assembly using a cartridge, coupled to the inkjet head at the outside of the inkjet head, as a substitute for a reservoir formed inside the inkjet head and containing ink, without forming the reservoir inside the inkjet head.

According to an aspect of the present invention, there is provided an inkjet head including an inkjet head plate slantedly coupled to a cartridge supplying ink; a nozzle ejecting ink moving through a path formed inside the inkjet head plate, and formed at a flattened edge of the inkjet head plate contacting a printing medium; and an actuator provided on a surface of the inkjet head plate opposite to that coupled to the cartridge and controlling the ejection of the ink.

The inkjet head plate may be formed by stacking a plurality of substrates having holes constituting the path formed therein.

The inkjet head plate may include a pressure chamber transferring the driving power of the actuator to the ink stored by being introduced from the cartridge and allowing the ink to move toward the nozzle; and a restrict allowing the ink of the cartridge to move toward the pressure chamber and preventing the ink of the pressure chamber from being reintroduced to the cartridge.

The inkjet head plate may further include a damper formed between the actuator and the nozzle in order to allow the driving power generated in the actuator to be focused on the nozzle and reduce rapid pressure variations at the nozzle.

The flattened edge may be formed by cutting a line intersecting a point on a side surface of a height direction of the inkjet head plate and a point on a side surface of a width direction thereof.

The flattened edge may be a surface flush with a bottom surface of the cartridge.

The flattened edge may be slantedly formed at an angle of 10° to 80° with respect to a side surface of a width direction of the inkjet head plate.

The nozzle may be formed to be perpendicular to the flattened edge.

According to another aspect of the present invention, there is provided an inkjet head assembly including a cartridge storing ink; an inkjet head plate slantedly coupled to the cartridge; and an actuator provided on a surface of the inkjet head plate opposite to that coupled to the cartridge and supplying driving power allowing the ink stored in a pressure chamber inside the inkjet head plate to be ejected in the form of droplets through a nozzle formed at a flattened edge of the inkjet head plate.

The nozzle may be formed to be perpendicular to the flattened edge formed by cutting a line intersecting a point on a side surface of a height direction of the inkjet head plate and a point on a side surface of a width direction thereof.

The flattened edge may be a surface flush with a bottom surface of the cartridge.

The flattened edge may be slantedly formed at an angle of 10° to 80° with respect to a side surface of a width direction of the inkjet head plate.

The inkjet head plate may include a restrict allowing the ink of the cartridge to move toward the pressure chamber and preventing a reversed movement; and a damper connected to the pressure chamber, transferring the driving power of the actuator to the nozzle, and reducing rapid pressure variations of the nozzle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an inkjet head assembly according to an exemplary embodiment of the present invention;

FIG. 2 is an exploded perspective view illustrating an inkjet head assembly according to an exemplary embodiment of the present invention;

FIG. 3 is a cross-sectional view illustrating the coupling state of a cartridge to an inkjet head according to an exemplary embodiment of the present invention;

FIG. 4 is a cross-sectional view illustrating the stacked structure of an inkjet head according to an exemplary embodiment of the present invention; and

FIG. 5 is a schematic cross-sectional view illustrating the ejection of ink from an inkjet head assembly according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to refer to the same or like parts.

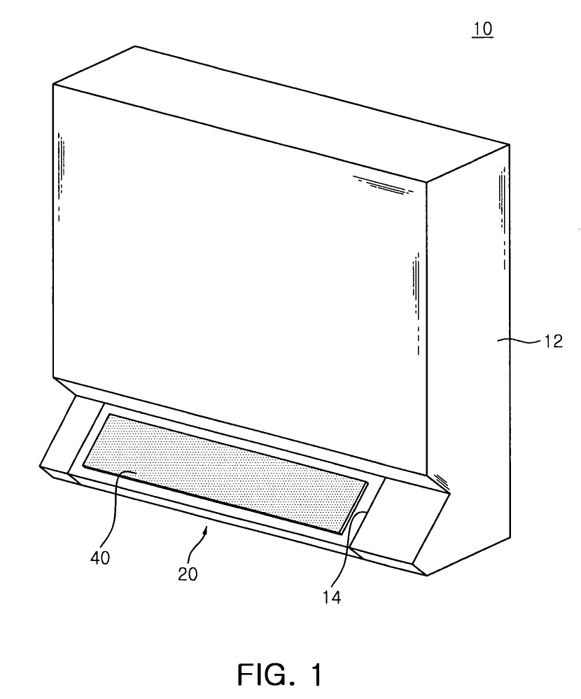

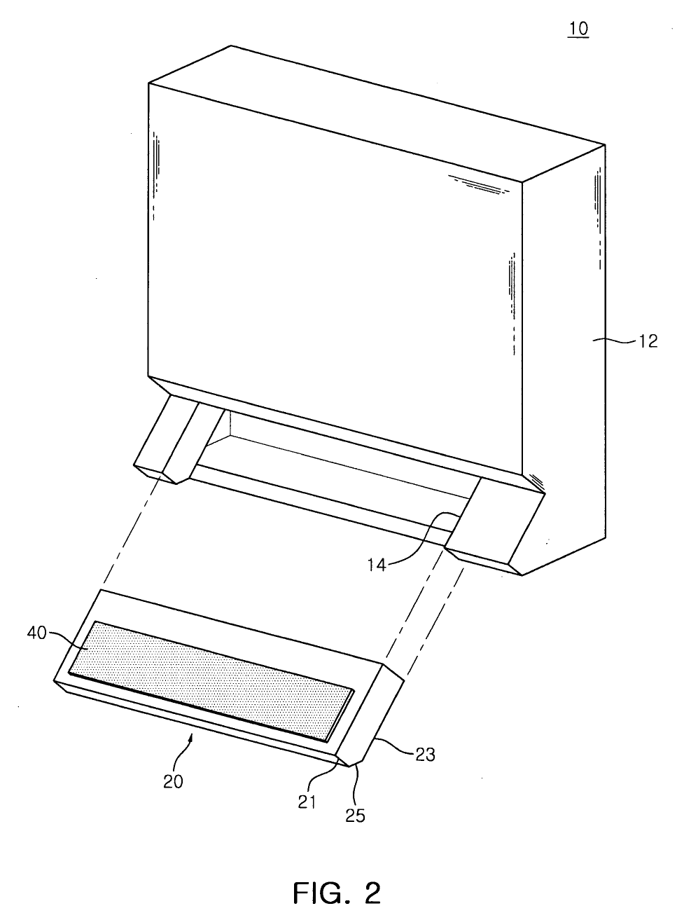

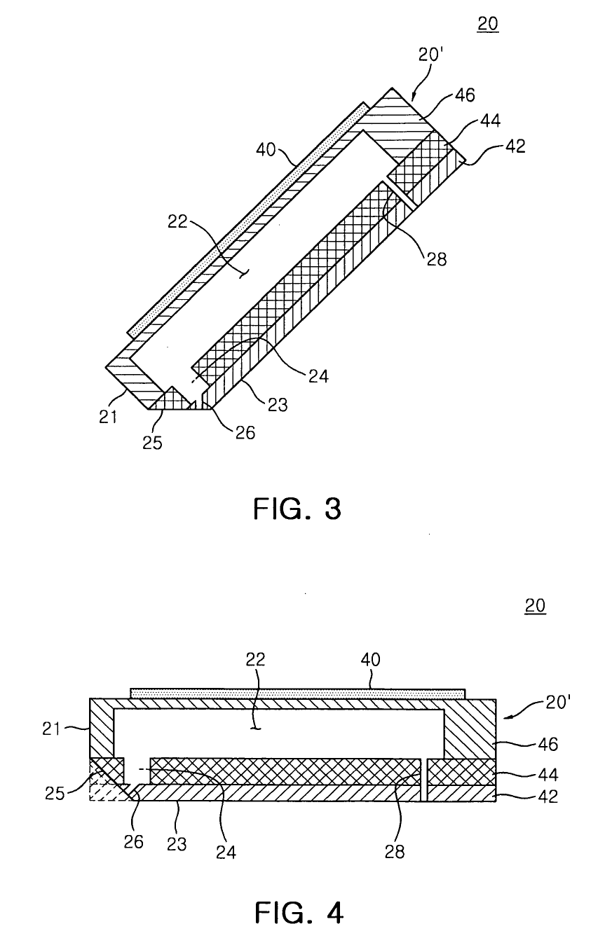

FIG. 1 is a perspective view illustrating an inkjet head assembly according to an exemplary embodiment of the present invention. FIG. 2 is an exploded perspective view illustrating an inkjet head assembly according to an exemplary embodiment of the present invention. FIG. 3 is a cross-sectional view illustrating the coupling state of a cartridge to an inkjet head according to an exemplary embodiment of the present invention.

Referring to FIGS. 1 through 3, an inkjet head 20 according to this embodiment may include an inkjet head plate 20′, a nozzle 26, and an actuator 40.

In another aspect, an inkjet head assembly 10 may include a cartridge 12 containing ink, the inkjet head plate 20′, and the actuator 40.

Hereinafter, a detailed description of components is applied to both the inkjet head 20 and the inkjet head assembly 10.

The inkjet head plate 20′ is slantedly coupled to the cartridge 12 supplying ink. The cartridge 12 has an inkjet head receiving portion 14 for accommodating the inkjet head plate 20′. The inkjet head receiving portion 14 allows the inkjet head plate 20′ to be slantedly coupled to the cartridge 12.

The nozzle 26 allows ink droplets to be ejected through a path formed inside the inkjet head plate 20′. Here, the nozzle 26 is formed to be perpendicular to a flattened edge 25 of the inkjet head plate 20′.

Here, the flattened edge 25 may contact a printing medium in a parallel manner. Also, the flattened edge 25 may be a surface flush with the bottom surface of the cartridge 12.

The flattened edge 25 may be formed by cutting a line intersecting a point on a side surface 21 of the height direction of the inkjet head plate 20′ and a point on a side surface 23 of the width direction thereof.

Also, since the cartridge 12 and the inkjet head plate 20′ are slantedly coupled to each other, the flattened edge 25 may be slantedly formed at an angle of 10° to 80° with respect to the side surface 23 of the width direction of the inkjet head plate 20′.

Meanwhile, the inkjet head plate 20′ may be formed by stacking a plurality of substrates having holes constituting an ink path formed therein.

In the embodiment of FIG. 3, the inkjet head plate 20′ may be sequentially formed by stacking a lower substrate 42, an intermediate substrate 44, and an upper substrate 46 in an inflow direction of the ink from the cartridge 12.

Here, the lower substrate 42 has the nozzle 26 and a restrict 28 formed therein. The intermediate substrate 44 has a damper 24 and the restrict 28 formed therein. The upper substrate 46 has a pressure chamber 22 formed therein. That is, the inkjet head plate 20′ may include the pressure chamber 22 transferring the driving power of the actuator 40 to stored ink and allowing the ink to move toward the nozzle 26 and the restrict 28 allowing the ink of the cartridge 12 to move toward the pressure chamber 22 and preventing the ink in the pressure chamber 22 from being reintroduced to the cartridge 12.

Also, the inkjet head plate 20′ may further include the damper 24 formed between the actuator 40 and the nozzle 26 so as to focus the driving power generated in the actuator 40 on the nozzle 26 and reduce rapid pressure variations at the nozzle 26.

Here, the damper 24 may be selectively formed. In the case that the formation of the damper 24 is omitted, the inkjet head plate 20′ may be constructed with only the lower substrate 42 and the upper substrate 26. If constructed in this manner, the inkjet head plate 20′ may be constructed by using two substrates, whereby the overall thickness thereof may be reduced, and also the inkjet head plate 20′ may be easily manufactured.

Meanwhile, the actuator 40 allows for the ejection of ink by modifying a membrane forming the upper surface of the pressure chamber 22. The actuator 40 may be a piezoelectric device formed with a piezoelectric element and having upper and lower electrodes attached to both surfaces of the piezoelectric element. The piezoelectric element may convert electrical energy to mechanical energy or vice versa, and its representative material is Pb(Zr,Ti)O₃. Also, the actuator 40 may be a bubble jet or thermal jet type actuator besides a piezoelectric type actuator.

FIG. 4 is a cross-sectional view illustrating the stacked structure of an inkjet head according to an exemplary embodiment of the present invention.

Referring to FIG. 4, the inkjet head plate 20′ is illustrated horizontally. In order to form the flattened corner 25, the line intersecting a point on the side surface 21 of the height direction of the inkjet head plate 20′ and a point on the side surface 23 of the width direction thereof is cut.

In the present embodiment, only the lower substrate 42 having the restrict 28 formed therein and the intermediate substrate 44 having the damper 24 formed therein are cut. Meanwhile, holes formed in the substrates are formed by an MEMS fabricating process.

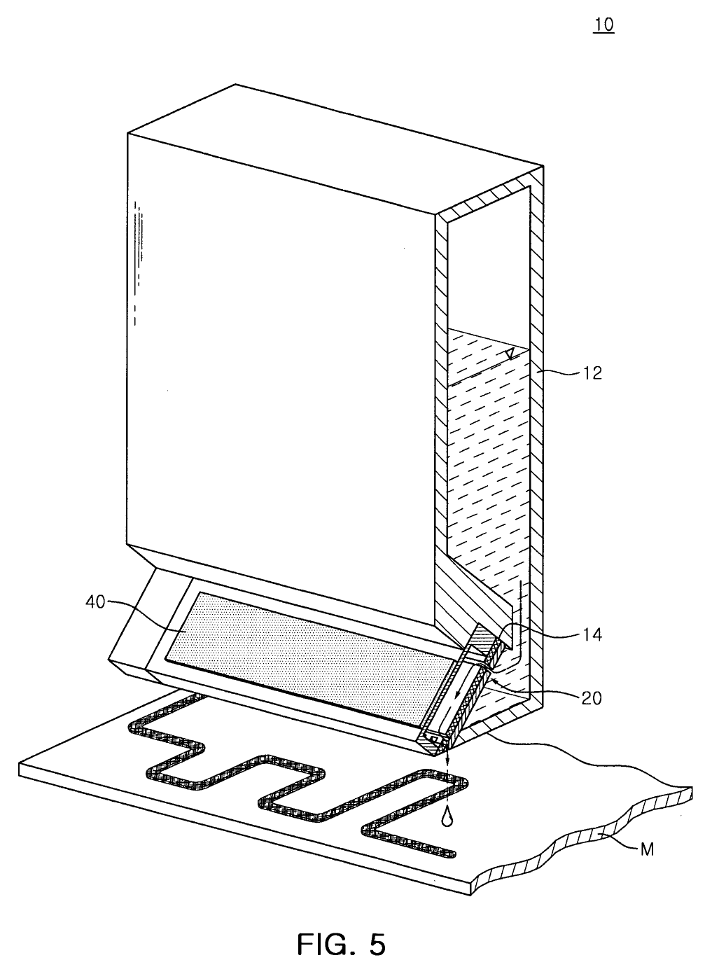

FIG. 5 is a schematic cross-sectional view illustrating the ejection of ink from an inkjet head assembly according to an exemplary embodiment of the present invention.

Referring to FIG. 5, the inkjet head assembly 10 as depicted according to the present invention allows a conductive pattern to be formed on a printed circuit board (PCB). That is, industrial ink contained in the cartridge 12 is drawn into the pressure chamber 22 through the restrict 28 of the inkjet head plate 20′. The ink stored in the pressure chamber 22 passes through the nozzle 26 and is ejected in the form of droplets by the driving power supplied by the actuator 40 provided on a surface of the inkjet head plate 20′ opposite to that coupled to the cartridge 12.

Here, the ink used is an industrial ink capable of forming a conductive pattern on the PCB which is a printing medium M. The conductive pattern of the PCB may be easily formed by the inkjet head assembly 10.

The inkjet head and the inkjet head assembly according to the present invention are able to use an inkjet cartridge in the outside of the inkjet head as a substitute for a reservoir formed inside an inkjet head plate. This causes a space corresponding to the reservoir to be saved in the inkjet head, resulting in a reduction in the overall thickness of the inkjet head plate.

Also, there is no need to manufacture a substrate in which the reservoir is formed, so the number of substrates is reduced and the manufacturing process is simplified.

As set forth above, according to exemplary embodiments of the invention, the inkjet head and the inkjet head assembly are able to use the inkjet cartridge in the outside of the inkjet head as a substitute for the reservoir formed inside the inkjet head plate, so a space corresponding to the reservoir is saved in the inkjet head, whereby the overall thickness of the inkjet head plate is reduced.

Also, there is no need to manufacture a substrate in which the reservoir is formed, so the number of substrates is reduced and the manufacturing process is simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
an inkjet head plate slantedly coupled to a cartridge supplying ink;
a nozzle ejecting ink moving through a path formed inside the inkjet head plate, and formed at a flattened edge of the inkjet head plate contacting a printing medium; and
an actuator provided on a surface of the inkjet head plate opposite to that coupled to the cartridge and controlling ejection of the ink.

2. The inkjet head of claim 1, wherein the inkjet head plate is formed by stacking a plurality of substrates having holes constituting the path formed therein.

3. The inkjet head of claim 1, wherein the inkjet head plate comprises:
a pressure chamber transferring driving power of the actuator to the ink stored by being introduced from the cartridge and allowing the ink to move toward the nozzle; and
a restrict allowing the ink of the cartridge to move toward the pressure chamber and preventing the ink of the pressure chamber from being reintroduced to the cartridge.

4. The inkjet head of claim 3, wherein the inkjet head plate further comprises a damper formed between the actuator and the nozzle in order to allow the driving power generated in the actuator to be focused on the nozzle and reduce rapid pressure variations at the nozzle.

5. The inkjet head of claim 1, wherein the flattened edge is formed by cutting a line intersecting a point on a side surface of a height direction of the inkjet head plate and a point on a side surface of a width direction thereof.

6. The inkjet head of claim 1, wherein the flattened edge is a surface flush with a bottom surface of the cartridge.

7. The inkjet head of claim 1, wherein the flattened edge is slantedly formed at an angle of 10° to 80° with respect to a side surface of a width direction of the inkjet head plate.

8. The inkjet head of claim 7, wherein the nozzle is formed to be perpendicular to the flattened edge.

9. An inkjet head assembly comprising:
a cartridge storing ink;
an inkjet head plate slantedly coupled to the cartridge; and
an actuator provided on a surface of the inkjet head plate opposite to that coupled to the cartridge and supplying driving power allowing the ink stored in a pressure chamber inside the inkjet head plate to be ejected in the form of droplets through a nozzle formed at a flattened edge of the inkjet head plate.

10. The inkjet head assembly of claim 9, wherein the nozzle is formed to be perpendicular to the flattened edge formed by cutting a line intersecting a point on a side surface of a height direction of the inkjet head plate and a point on a side surface of a width direction thereof.

11. The inkjet head assembly of claim 10, wherein the flattened edge is a surface flush with a bottom surface of the cartridge.

12. The inkjet head assembly of claim 10, wherein the flattened edge is slantedly formed at an angle of 10° to 80° with respect to a side surface of a width direction of the inkjet head plate.

13. The inkjet head assembly of claim 9, wherein the inkjet head plate comprises:
a restrict allowing the ink of the cartridge to move toward the pressure chamber and preventing a reversed movement; and
a damper connected to the pressure chamber, transferring the driving power of the actuator to the nozzle, and reducing rapid pressure variations of the nozzle.
